(19) United States
(12) Patent Application Publication
(10) Pub. No.: US 2024/0317922 A1
(43) Pub. Date: Sep. 26, 2024

(54) Renewable material-based furandicarboxylic acid coating material of polyurethane controlled release fertilizer and its application and product

(71) Applicant: Qingyang Economic Development Zone, Chizhou (CN)

(72) Inventors: Chenghu Zhong, Chizhou (CN); Yujie Zhu, Chizhou (CN)

(21) Appl. No.: 18/677,900

(22) Filed: May 30, 2024

(30) Foreign Application Priority Data
Mar. 28, 2024 (CN) 2024103641580

(51) Int. Cl. C08G 18/36; C05C 9/00; C05G 5/30; C08G 18/76

(52) U.S. Cl. CPC C08G 18/36; C05C 9/005; C05G 5/37; C08G 18/7664

(57) ABSTRACT

A renewable material-based furandicarboxylic acid (Bio-FDCA) coating material of a polyurethane controlled release fertilizer is prepared by performing cross-linking reaction between at least one polyester polyol and at least one isocyanate, wherein the polyester polyol is made from the Bio-FDCA. Moreover, a method for preparing a polyurethane controlled release fertilizer includes by spraying the coating material on a surface of granular fertilizer, forming a layer of film after cross-linking in situ on the surface of the granular fertilizer, so as to obtain the polyurethane controlled release fertilizer. In the present invention, it is the first time to introduce the furan ring structure into the coating material of the polyurethane controlled release fertilizer, and the Bio-FDCA is taken as the source of the furan ring structure.

### CROSS REFERENCE OF RELATED APPLICATION

The present invention claims priority under 35 U.S.C. 119(a-d) to CN 202410364158.0, filed Mar. 28, 2024.

### BACKGROUND OF THE PRESENT INVENTION

### Field of Invention

The present invention relates to the technical field of controlled release fertilizer, especially it relates to the technical field of IPC classification number C05G3/40, and more particularly to a method for preparing a renewable material-based furandicarboxylic acid coating material of a polyurethane controlled release fertilizer, the coating material prepared by the method, and the polyurethane controlled release fertilizer with the coating material.

### Description of Related Arts

Polymer polyols are one of the key raw materials that determine the properties of polyurethane materials. Most of the commercialized polyester polyols are prepared by dehydration and condensation of simple adipic acid and polyols with small molecular structure under vacuum and high temperature. Polyurethane products based on the above polyester polyols have excellent properties such as high mechanical strength, oil resistance, heat resistance and aging resistance. However, at the same time, there are obvious shortcomings such as hydrolysis resistance, salt spray resistance, and alternating moisture and heat difference resistance. In order to improve these properties, the industry generally adopts the method of introducing a small proportion of phthalic acid, iso-phthalic acid, or p-phthalic acid. The addition of aromatic structure not only increases the rigidity of the molecular main chain, but also further improves the mechanical properties of polyurethane products. At the same time, due to the steric resistance and crystallization factors, the introduction of aromatic structure has a certain improvement on the water resistance and other properties of the material. However, due to the weak hydrophobic property after the introduction of phthalic acid, the release period of the prepared controlled release fertilizer is short when the prepared polyester polyol is applied in the field of controlled release fertilizer, which also limits the application of polyester polyol in downstream products, such as controlled release fertilizer.

Bio-based polyester polyols are new materials prepared by biological, chemical and physical methods using renewable biomass as raw materials. With the emergence of bio-based materials, they are able to simultaneously meet the needs of low-carbon environmental protection and meet the diversified consumer needs of the market. Therefore, bio-based materials have become a new choice in the current carbon-neutral era background. Bio-based materials have many advantages such as green and low-carbon, energy saving and environmental protection, and renewable raw materials. They have good biodegradability, and are able to be widely used.

Chinese patent document CN 116515079A discloses a bio-based coating material of a polyurethane controlled release fertilizer and the polyurethane controlled release fertilizer. The coating material is prepared by performing cross-linking reaction between bio-based 1,5-pentane diisocyanate complex and bio-based polyol. The bio-based polyol is prepared by performing ring-opening polymerization among epoxidized fatty acid ester, lactic acid and bio-based alcohol. The bio-based acid used in this patent is lactic acid, which has a small molecular weight and contains certain polar functional groups, and has a certain hydrophilicity. Although it is hydrophobic after esterification with bio-based alcohols and esterification catalysts, its hydrophobic performance is weak. Therefore, when the lactic acid is used to prepare the coating material, it is necessary to improve the hydrophobic performance and extend the controlled release period by increasing the thickness, resulting in higher cost.

Chinese patent CN 115873200A discloses another bio-based polyol for preparing polyurethane controlled release fertilizer, which is obtained by liquefaction of biomass materials such as starch or straw. However, the preparation process of the bio-based polyol is complex, the biomass content thereof is low, and the controlled release period thereof is only able to reach 60 days under low coating rate. Furthermore, the extension of the controlled release period is only able to be achieved by increasing the coating rate, which will lead to the increase in production costs.

### SUMMARY OF THE PRESENT INVENTION

Aiming at deficiencies of the prior art, an object of the present invention is to provide a coating material of a polyurethane controlled release fertilizer containing renewable material-based furandicarboxylic acid (Bio-FDCA), which has high biological degradability, strong hydrophobicity and good sealing performance, is environmentally friendly and safe, and is suitable for mass production.

Another object of the present invention is to provide a method of preparing a polyurethane controlled release fertilizer, which comprises a step of coating the above coating material on a surface of granular fertilizer.

Another object of the present invention is to provide a polyurethane controlled release fertilizer which is prepared by the above method.

To achieve the above objects, the present invention adopts technical schemes as follows.

A renewable material-based furandicarboxylic acid (Bio-FDCA) coating material of a polyurethane controlled release fertilizer is provided, wherein the coating material comprises a structural unit of

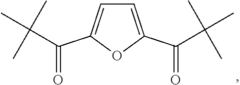

and is prepared by performing cross-linking reaction between at least one polyester polyol and at least one isocyanate, wherein the polyester polyol is made from the Bio-FDCA.

In the present invention, it is the first time to introduce the furan ring structure into the coating material of the polyurethane controlled release fertilizer. Compared with the aromatic structure of the benzene ring introduced in the traditional method, the furan ring structure has better water resistance, which is beneficial to prolong the release period of the polyurethane controlled release fertilizer. Moreover, in the present invention, the Bio-FDCA is taken as the source of the furan ring structure, so that on the basis of improving the properties of the coating material, the biomass content thereof is also increased, thereby obtaining higher biocompatibility and ecological safety.

Preferably, an infrared spectrum of the coating material of the polyurethane controlled release fertilizer has characteristic peaks in the range of 1598-1600 cm⁻¹, 1220-1225 cm⁻¹, 1070-1075 cm⁻¹, 818-823 cm⁻¹, and 764-768 cm⁻¹.

The coating material of the polyurethane controlled release fertilizer provided by the present invention is obtained by performing cross-linking reaction between polyester polyol, which is made from the Bio-FDCA, and isocyanate. It is able to seen from the infrared spectrogram that the coating material of the polyurethane controlled release fertilizer provided by the present invention has the corresponding characteristic absorption of furan dimethyl ester, such as the stretching vibration peak of C═C of the furan ring in the range of 1598-1600 cm⁻¹, the stretching vibration of C═O of the ester group directly connected with the furan ring in the range of 1220-1225 cm⁻¹, the stretching vibration of C—O—C of the furan ring in the range of 1070-1075 cm⁻¹, the out-of-plane bending vibration of C—H of the benzene ring or the furan ring of isocyanate in the range of 818-823 cm⁻¹ and 764-768 cm⁻¹, the characteristic absorption in the range of 764-768 cm⁻¹ is produced by the out-of-plane bending vibration of C—H of the furan ring, so that the characteristic absorption peak strength of the coating material, which is made from Bio-FDCA provided by the present invention, in the range of 764-768 cm⁻¹ is significantly greater than that in the range of 818-823 cm⁻¹.

Preferably, raw materials for preparing the polyester polyol comprise Bio-FDCA, at least one organic monacid or organic binary acid, at least one polyol, and a catalyst.

The Bio-FDCA is made from renewable materials, such as furfural, furoic acid, furan, hexose diacid, fructose, glucose and diglycolic acid.

Preferably, the raw materials for preparing the polyester polyol, in part by weight, comprise 4-40 parts of the Bio-FDCA, 17-55 parts of the organic monacid or organic binary acid, 30-60 parts of the polyol, and 0.05-0.2 parts of the catalyst.

Preferably, the organic monacid or organic binary acid is at least one member selected from a group consisting of adipic acid, succinic acid, glutaric acid, sebacic acid, vegetable oleic acid and acetic acid; and more preferably, the vegetable oleic acid is at least one member selected from a group consisting of oleic acid, linoleic acid, erucic acid, ricinoleic acid, soybean oleic acid, rapeseed oleic acid, eiconsenoic acid, sunflower oleic acid, and palmitoleic acid.

Preferably, the polyol is at least one member selected from a group consisting of diethylene glycol, butanediol, propylene glycol, pentanediol, hexanediol, diethylene glycol, and glycerol.

The Bio-FDCA, the organic monacid or organic binary acid, and the polyol of the present invention are biological sources or made from materials of biological origin.

Preferably, the catalyst is any one of organic titanate catalyst, organic tin catalyst and zinc acetate; and more preferably, the organic titanate catalyst is isopropyl titanate or tetrabutyl titanate; the organic tin catalyst is dibutyltin oxide or dibutyltin dilaurate.

Preferably, raw materials for preparing the polyester polyol comprise Bio-FDCA, adipic acid, diethylene glycol, glycerol and a catalyst; and
more preferably, raw materials for preparing the polyester polyol, in parts by weight, comprise 10-30 parts of the Bio-FDCA, 17-40 parts of the adipic acid, 35-60 parts of the diethylene glycol, 0-20 parts of the glycerol, and 0.05-0.2 parts of the catalyst.

Preferably, raw materials for preparing the polyester polyol comprise Bio-FDCA, adipic acid, vegetable oleic acid, acetic acid, glycerol and a catalyst; and
more preferably, raw materials for preparing the polyester polyol, in parts by weight, comprise 10-20 parts of the Bio-FDCA, 5-15 parts of the adipic acid, 40-45 parts of the vegetable oleic acid, 2-10 parts of the acetic acid, 30-45 parts of the glycerol, and 0.05-0.2 parts of the catalyst.

Preferably, raw materials for preparing the polyester polyol comprise Bio-FDCA, adipic acid, butanediol, propylene glycol and a catalyst; and
more preferably, raw materials for preparing the polyester polyol, in parts by weight, comprise 10-15 parts of the Bio-FDCA, 40-50 parts of the adipic acid, 33-38 parts of the butanediol, 17-22 parts of the propylene glycol and 0.05-0.2 parts of the catalyst.

Preferably, by mass percentage, the Bio-FDCA accounts for 4% to 40% of the polyester polyol; and
more preferably, the Bio-FDCA accounts for 10% to 30% of the polyester polyol; and further preferably, the Bio-FDCA accounts for 10% to 20% of the polyester polyol.

Preferably, a viscosity of the polyester polyol is in a range of 500 to 30000 mPa·s at 25° C.; and
more preferably, the viscosity of the polyester polyol is in a range of 1500 to 15000 mPa·s at 25° C.

Preferably, the polyester polyol is prepared by steps of:
putting the raw materials for preparing the polyester polyol into a reaction container, performing refluxing after heating, performing vacuum distillation till an acidity grade is less than 2.0 mgKOH/g and a moisture mass fraction is less than 0.1%, so as to obtain the polyester polyol.

Specifically, the polyester polyol is prepared by steps of:
putting the Bio-FDCA, the adipic acid, the diethylene glycol, the glycerol and the catalyst into the reaction container, performing a first refluxing for 5-10 hours after heating to 150-170° C., performing a second refluxing after heating to 200-240° C. till the acidity grade is less than 5.0 mgKOH/g, decreasing to 180-220° C., performing vacuum distillation till the acidity grade is less than 2.0 mgKOH/g and the moisture mass fraction is less than 0.1%, so as to obtain the polyester polyol with a viscosity in a range of 4000 to 10000 mPa·s, and a hydroxyl value in a range of 150 to 350 mgKOH/g;
or the polyester polyol is prepared by steps of:
putting the vegetable oleic acid, the acetic acid and the glycerol into the reaction container, performing esterification reaction by heating to 160-240° C. till an acidity grade is less than 10 mgKOH/g for obtaining vegetable oleic acid glyceride, adding the Bio-FDCA, the adipic acid and the catalyst into the vegetable oleic acid glyceride, performing a first refluxing for 5-10 hours after heating to 150-170° C., performing a second refluxing after heating to 200-240° C. till the acidity grade is less than 5.0 mgKOH/g, decreasing to 180-220° C., performing vacuum distillation till the acidity grade is less than 2.0 mgKOH/g and the moisture mass fraction is less than 0.1%, so as to obtain the polyester polyol with a viscosity in a range of 7000 to 10000 mPa·s, and a hydroxyl value in a range of 200 to 400 mgKOH/g;
or the polyester polyol is prepared by steps of:
putting the Bio-FDCA, the adipic acid, the butanediol, the propylene glycol and the catalyst into the reaction container, performing a first refluxing for 5-10 hours after heating to 150-170° C., performing a second refluxing after heating to 200-240° C. till an acidity grade is less than 5.0 mgKOH/g, decreasing to 180-220° C., performing vacuum distillation till the acidity grade is less than 2.0 mgKOH/g and the moisture mass fraction is less than 0.1%, so as to obtain the polyester polyol with a viscosity in a range of 4000 to 8000 mPa·s, and a hydroxyl value in a range of 200 to 400 mgKOH/g.

Preferably, the isocyanate has more than two isocyanate groups.

Preferably, the isocyanate comprises petroleum-based polymethylene polyphenyl polyisocyanate and bio-based polymethylene polyphenyl polyisocyanate; and more preferably, the isocyanate is at least one member selected from a group consisting of petroleum-based diphenylmethane diisocyanate (MDI), bio-based diphenylmethane diisocyanate, toluene diisocynate (TDI), p-phenylene diisocyanate (PPDI), m-xylylene Diisocyanate (XDI), cyclohexyl diisocyanate (CHDI), isophorone diisocyanate (IPDI), dicyclohexylmethane diisocyanate (HMDI), Hexamethylene diisocyanate (HDI) and Lysine diisocyanate (LDI);
and more preferably, the bio-based MDI is obtained by synthesizing bio-based aniline.

Preferably, a molar ratio of a hydroxyl group of the polyester polyol and an NCO group of the isocyanate is in a range of (1-1.05):1.

Also, a method for preparing a polyurethane controlled release fertilizer is provided. The method comprises by spraying the polyester polyol and the isocyanate on a surface of granular fertilizer, forming a layer of film after cross-linking in situ on the surface of the granular fertilizer, so as to obtain the polyurethane controlled release fertilizer.

Preferably, a weight of the coating material accounts for 2-6% of that of the polyurethane controlled release fertilizer;
and more preferably, the weight of the coating material accounts for 2-4% of that of the polyurethane controlled release fertilizer.

Also, a polyurethane controlled release fertilizer prepared by the above method is provided.

Compared with the prior art, the present invention has some beneficial effects as follows.
(1) The coating material of the polyurethane controlled release fertilizer provided by the present invention is made from bio-based materials, which has good biocompatibility, easy degradation, high ecological safety, green environmental protection, meets the development requirements of green chemistry, and will not cause soil pollution.
(2) The present invention innovatively discloses a high hydrophobic polyester polyol. According to the present invention, only a small amount of Bio-FDCA is needed to significantly improve the hydrophobic sealing performance of the prepared polyurethane material, thereby prolonging the controlled release period of the polyurethane controlled release fertilizer. At the same time, the present invention also takes into account the cost, and has practical industrialization value.
(3) The polyester polyol provided by the present invention has suitable viscosity, is able to form a layer of film on the surface of the granular fertilizer with the isocyanate by in-situ crosslinking. It has excellent operability, and is suitable for industrial expansion production.
(4) The coating material of the polyurethane controlled release fertilizer provided by the present invention has good hydrophobicity and air tightness, and has high strength and toughness. When coating the coating material on the granular fertilizer, a lower coating rate is used, that is, the controlled release effect equivalent to the existing products on the market is able to be achieved with a lower amount of the polyurethane controlled release fertilizer, further reducing the use cost of the bio-based materials.
(5) The present invention applies Bio-FDCA to the field of the coating material of the controlled release fertilizer for the first time, and constructs a new bio-based coating material system of the controlled release fertilizer, which is able to replace the existing bio-based controlled release fertilizer due to excellent performance.

### BRIEF DESCRIPTION OF THE DRAWINGS

FIG. 1 shows an infrared spectrum of polyester polyol (upper) and that of a coating material of a polyurethane controlled release fertilizer (lower) according to the first embodiment of the present invention.

FIG. 2 shows an infrared spectrum of polyester polyol (upper) and that of a coating material of a polyurethane controlled release fertilizer (lower) according to the second embodiment of the present invention.

FIG. 3 shows an infrared spectrum of polyester polyol (upper) and that of a coating material of a polyurethane controlled release fertilizer (lower) according to the third embodiment of the present invention.

FIG. 4 shows an infrared spectrum of polyester polyol (upper) and that of a coating material of a polyurethane controlled release fertilizer (lower) according to the fifth embodiment of the present invention.

FIG. 5 shows an infrared spectrum of polyester polyol (upper) and that of a coating material of a polyurethane controlled release fertilizer (lower) according to the seventh embodiment of the present invention.

FIG. 6 shows an infrared spectrum of polyester polyol (upper) and that of a coating material of a polyurethane controlled release fertilizer (lower) according to the first comparative example of the present invention.

FIG. 7 shows an infrared spectrum of polyester polyol (upper) and that of a coating material of a polyurethane controlled release fertilizer (lower) according to the second comparative example of the present invention.

FIG. 8 is a partial enlarged drawing of characteristic peaks of the infrared spectrum of the coating material of the polyurethane controlled release fertilizer according to the first embodiment of the present invention.

FIG. 9 is a sample photo of polyester polyols, in which numbers “1” to “7” are corresponding to the polyester polyols according to the first, second, third, fifth and seventh embodiments, and the first and second comparative examples of the present invention, respectively.

FIG. 10 is a sample photo of a solidified polyurethane film, in which letters “a” to “g” are corresponding to the solidified polyurethane films according to the first, second, third, fifth and seventh embodiments, and the first and second comparative examples of the present invention, respectively.

### DETAILED DESCRIPTION OF THE PREFERRED EMBODIMENT

The present invention is further explained in combination with embodiments as follows. The following embodiments are only used to clarify the technical schemes of the present invention more clearly, and are not intended to limit the protection scope of the present invention.

### First Embodiment

A renewable material-based furandicarboxylic acid (Bio-FDCA) coating material of a polyurethane controlled release fertilizer according to the first embodiment of the present invention is provided. Raw materials for preparing the coating material comprise polyester polyol and isocyanate. Raw materials for preparing the polyester polyol, in parts by weight, comprise 11 parts of Bio-FDCA, 39 parts of adipic acid, 40 parts of diethylene glycol, 12 parts of glycerol and 0.1 parts of zinc acetate which acts as a catalyst. In this embodiment, the isocyanate is petroleum-based diphenylmethane diisocyanate (MDI) which is embodied as PM-200 purchased from Wanhua Chemical Group Co., Ltd., China.

The polyester polyol in this embodiment is prepared by steps of:
putting the above parts of the Bio-FDCA, the adipic acid, the diethylene glycol and the glycerol into a reaction container, adding the above parts of the catalyst into the reaction container, performing the first refluxing for 6 hours after heating to 150° C., performing the second refluxing for 6 hours after heating to 200° C., detecting an acidity grade, stopping the second refluxing when the acidity grade is less than 5.0 mgKOH/g, decreasing to 180° C., performing vacuum distillation, wherein a vacuum degree is −0.065 MPa, and stopping vacuum distillation when the acidity grade is less than 2.0 mgKOH/g and a moisture mass fraction is less than 0.1%, so as to obtain the polyester polyol.

Also, a method of preparing the above polyurethane controlled release fertilizer is provided. The method comprises steps of weighing 1 kg of granular urea with a grain size in a range of 2.00 to 4.75 mm; putting the granular urea into a coating machine; heating to 65° C.; preparing the polyester polyol mentioned above and the isocyanate respectively; dividing the polyester polyol and the isocyanate into four equal parts respectively, wherein each of the four equal parts of the polyester polyol is 3.28 g, each of the four equal parts of the isocyanate is 1.97 g, a molar ratio of —OH of the polyester polyol to —NCO of the isocyanate is about 1:1; obtaining a mixture by mixing one of the four equal parts of the polyester polyol with one of the four equal parts of the isocyanate; by spraying the mixture on a surface of the granular urea, forming a layer of film after cross-linking in situ on the surface of the granular urea; repeating mixing and spraying for four times; after solidifying for 5 minutes, adding paraffin accounting for 0.2% of a total weight of the polyester polyol and the isocyanate to avoid adhesion; cooling to 20° C.; and discharging to obtain the polyurethane controlled release fertilizer, wherein an amount of the coating material is 2.1 wt % (coating ratio) of the polyurethane controlled release fertilizer.

Moreover, the present invention provides the polyurethane controlled release fertilizer prepared by the above method.

### Second Embodiment

A renewable material-based furandicarboxylic acid (Bio-FDCA) coating material of a polyurethane controlled release fertilizer according to the second embodiment of the present invention is provided. Raw materials for preparing the coating material comprise polyester polyol and isocyanate. Raw materials for preparing the polyester polyol, in parts by weight, comprise 20 parts of Bio-FDCA, 26 parts of adipic acid, 27.25 parts of diethylene glycol, 16 parts of glycerol and 0.05 parts of dibutyltin dilaurate which acts as a catalyst. In this embodiment, the isocyanate is petroleum-based diphenylmethane diisocyanate (MDI) which is embodied as PM-200 purchased from Wanhua Chemical Group Co., Ltd., China.

The preparation method of the polyester polyol and the method of preparing the polyurethane controlled release fertilizer in the second embodiment are the same as those in the first embodiment. Differences between the first and second embodiments are each of the four equal parts of the polyester polyol is 2.89 g, and each of the four equal parts of the isocyanate is 2.36 g.

### Third Embodiment

A renewable material-based furandicarboxylic acid (Bio-FDCA) coating material of a polyurethane controlled release fertilizer according to the third embodiment of the present invention is provided. Raw materials for preparing the coating material comprise polyester polyol and isocyanate. Raw materials for preparing the polyester polyol, in parts by weight, comprise 30 parts of Bio-FDCA, 17 parts of adipic acid, 56 parts of diethylene glycol, and 0.05 parts of dibutyltin dilaurate which acts as a catalyst. In this embodiment, the isocyanate is bio-based diphenylmethane diisocyanate (MDI) which is purchased from Badische Anilin-und-Soda-Fabrik (BASF) SE, Germany.

The preparation method of the polyester polyol and the method of preparing the polyurethane controlled release fertilizer in the third embodiment are the same as those in the first embodiment. Differences between the first and third embodiments are each of the four equal parts of the polyester polyol is 3.31 g, and each of the four equal parts of the isocyanate is 1.94 g.

### Fourth Embodiment

A renewable material-based furandicarboxylic acid (Bio-FDCA) coating material of a polyurethane controlled release fertilizer according to the fourth embodiment of the present invention is provided. Raw materials for preparing the coating material comprise polyester polyol and isocyanate. Raw materials for preparing the polyester polyol, in parts by weight, comprise 5 parts of Bio-FDCA, 48 parts of adipic acid, 43 parts of diethylene glycol, and 0.05 parts of dibutyltin dilaurate which acts as a catalyst. In this embodiment, the isocyanate is petroleum-based diphenylmethane diisocyanate (MDI) which is embodied as PM-200 purchased from Wanhua Chemical Group Co., Ltd., China.

The preparation method of the polyester polyol and the method for preparing the polyurethane controlled release fertilizer in the fourth embodiment are the same as those in the first embodiment. Differences between the first and fourth embodiments are each of the four equal parts of the polyester polyol is 3.80 g, and each of the four equal parts of the isocyanate is 1.45 g.

### Fifth Embodiment

A renewable material-based furandicarboxylic acid (Bio-FDCA) coating material of a polyurethane controlled release fertilizer according to the fifth embodiment of the present invention is provided. Raw materials for preparing the coating material comprise polyester polyol and isocyanate. Raw materials for preparing the polyester polyol, in parts by weight, comprise 11.7 parts of Bio-FDCA, 12 parts of adipic acid, 41 parts of soybean oleic acid, 6.7 parts of acetic acid, 32.5 parts of glycerol and 0.1 parts of zinc acetate which acts as a catalyst. In this embodiment, the isocyanate is petroleum-based diphenylmethane diisocyanate (MDI) which is embodied as PM-200 purchased from Wanhua Chemical Group Co., Ltd., China.

The polyester polyol in this embodiment is prepared by steps of:
(step 1) putting the above parts of the soybean oleic acid, the acetic acid and the glycerol into a reaction container, performing esterification reaction by heating to 220° C., detecting an acidity grade till the acidity grade is less than 10 mgKOH/g, and discharging a yellow transparent viscous liquid after decreasing, wherein the yellow transparent viscous liquid is vegetable oleic acid glyceride; and
(step 2) adding the above parts of the Bio-FDCA and the adipic acid into the vegetable oleic acid glyceride obtained by (step 1), adding the above parts of the catalyst, performing the first refluxing for 5 hours after heating to 170° C., performing the second refluxing for 6 hours after heating to 220° C., detecting an acidity grade, stopping the second refluxing when the acidity grade is less than 5.0 mgKOH/g, decreasing to 200° C., performing vacuum distillation, wherein a vacuum degree is-0.065 MPa, and stopping vacuum distillation when the acidity grade is less than 2.0 mgKOH/g and a moisture mass fraction is less than 0.1%, so as to obtain the polyester polyol.

The method for preparing the polyurethane controlled release fertilizer in the fifth embodiment is the same as that in the first embodiment. Differences between the first and fifth embodiments are each of the four equal parts of the polyester polyol is 3.34 g, and each of the four equal parts of the isocyanate is 1.91 g.

### Sixth Embodiment

A renewable material-based furandicarboxylic acid (Bio-FDCA) coating material of a polyurethane controlled release fertilizer according to the sixth embodiment of the present invention is provided. Raw materials for preparing the coating material comprise polyester polyol and isocyanate. Raw materials for preparing the polyester polyol, in parts by weight, comprise 17 parts of Bio-FDCA, 10 parts of adipic acid, 42 parts of soybean oleic acid, 2.2 parts of acetic acid, 44 parts of glycerol and 0.1 parts of zinc acetate which acts as a catalyst. In this embodiment, the isocyanate is bio-based diphenylmethane diisocyanate (MDI) which is purchased from Badische Anilin-und-Soda-Fabrik (BASF) SE, Germany.

The preparation method of the polyester polyol and the method for preparing the polyurethane controlled release fertilizer in the sixth embodiment are the same as those in the fifth embodiment. Differences between the fifth and sixth embodiments are each of the four equal parts of the polyester polyol is 2.79 g, and each of the four equal parts of the isocyanate is 2.46 g.

### Seventh Embodiment

A renewable material-based furandicarboxylic acid (Bio-FDCA) coating material of a polyurethane controlled release fertilizer according to the seventh embodiment of the present invention is provided. Raw materials for preparing the coating material comprise polyester polyol and isocyanate. Raw materials for preparing the polyester polyol, in parts by weight, comprise 11 parts of Bio-FDCA, 45 parts of adipic acid, 34 parts of butanediol, 19 parts of propylene glycol and 0.1 parts of zinc acetate which acts as a catalyst. In this embodiment, the isocyanate is petroleum-based diphenylmethane diisocyanate (MDI) which is embodied as PM-200 purchased from Wanhua Chemical Group Co., Ltd., China.

The polyester polyol in this embodiment is prepared by steps of:
putting the above parts of the Bio-FDCA, the adipic acid, the butanediol, and the propylene glycol into a reaction container, adding the above parts of the catalyst into the reaction container, performing the first refluxing for 4 hours after heating to 150° C., performing the second refluxing for 6 hours after heating to 200° C., detecting an acidity grade, stopping the second refluxing when the acidity grade is less than 5.0 mgKOH/g, decreasing to 180° C., performing vacuum distillation, wherein a vacuum degree is-0.065 MPa, and stopping vacuum distillation when the acidity grade is less than 2.0 mgKOH/g and a moisture mass fraction is less than 0.1%, so as to obtain the polyester polyol.

The method for preparing the polyurethane controlled release fertilizer in the seventh embodiment is the same as that in the first embodiment.

### First Comparative Example

A renewable material-based furandicarboxylic acid (Bio-FDCA) coating material of a polyurethane controlled release fertilizer according to the first comparative example of the present invention is provided. Raw materials for preparing the coating material comprise polyester polyol and isocyanate, wherein the polyester polyol is prepared by the method disclosed by the fifth embodiment in CN 113512172A, the isocyanate is diphenylmethane diisocyanate (MDI) which is embodied as PM-200 purchased from Wanhua Chemical Group Co., Ltd., China.

Also, the first comparative example provides the method for preparing the polyurethane controlled release fertilizer, which is the same as that in the first embodiment of the present invention. Differences between the first comparative example and the first embodiment of the present invention are each of the four equal parts of the polyester polyol is 3.36 g, and each of the four equal parts of the isocyanate is 1.89 g.

### Second Comparative Example

A renewable material-based furandicarboxylic acid (Bio-FDCA) coating material of a polyurethane controlled release fertilizer according to the second comparative example of the present invention is provided. Raw materials for preparing the coating material comprise polyester polyol and isocyanate, wherein the polyester polyol is MN-700 purchased from Shandong Bluestar Dongda Co., Ltd., China, and the isocyanate is diphenylmethane diisocyanate (MDI) which is embodied as PM-200 purchased from Wanhua Chemical Group Co., Ltd., China.

Also, the second comparative example provides the method for preparing the polyurethane controlled release fertilizer, which is the same as that in the first embodiment of the present invention. Differences between the second comparative example and the first embodiment of the present invention are each of the four equal parts of the polyester polyol is 3.32 g, and each of the four equal parts of the isocyanate is 1.93 g.

### Performance Testing (PT):

### (1) Infrared Characterization

The test samples of the polyurethane coating material used in the infrared standard are prepared respectively by a method, which comprises steps of mixing the polyester polyol with the isocyanate according to the corresponding parts by weight in the above embodiments and comparative examples, evenly coating on a surface of glass plates, and solidifying for 5 minutes at 60° C. for obtaining polyurethane films.

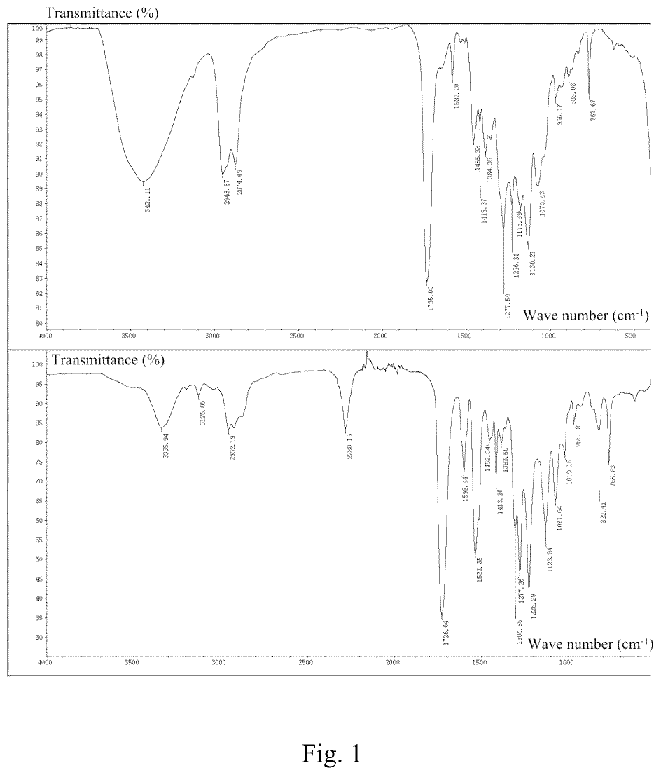

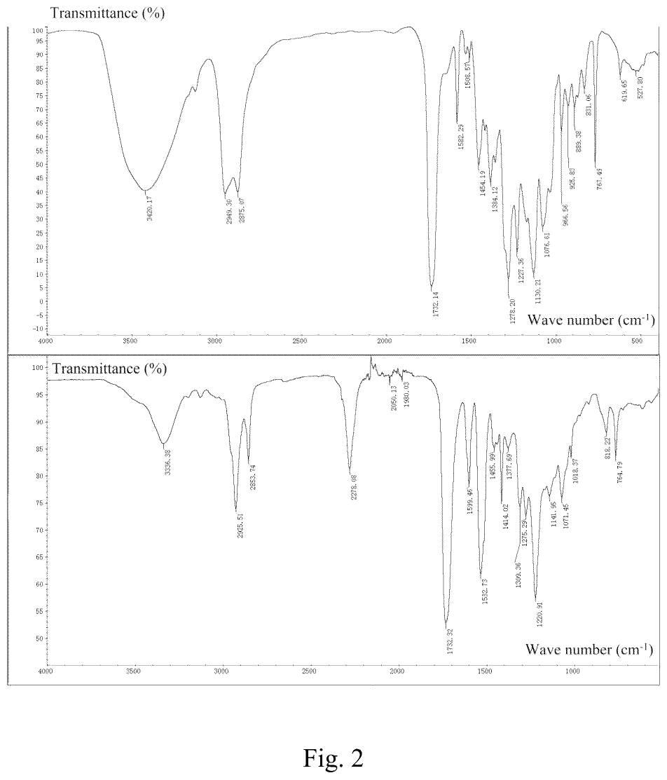

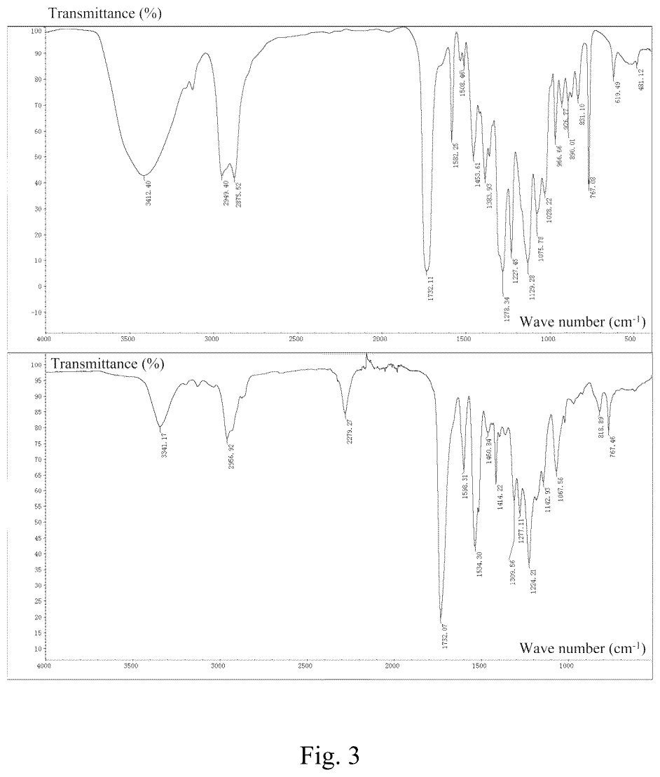

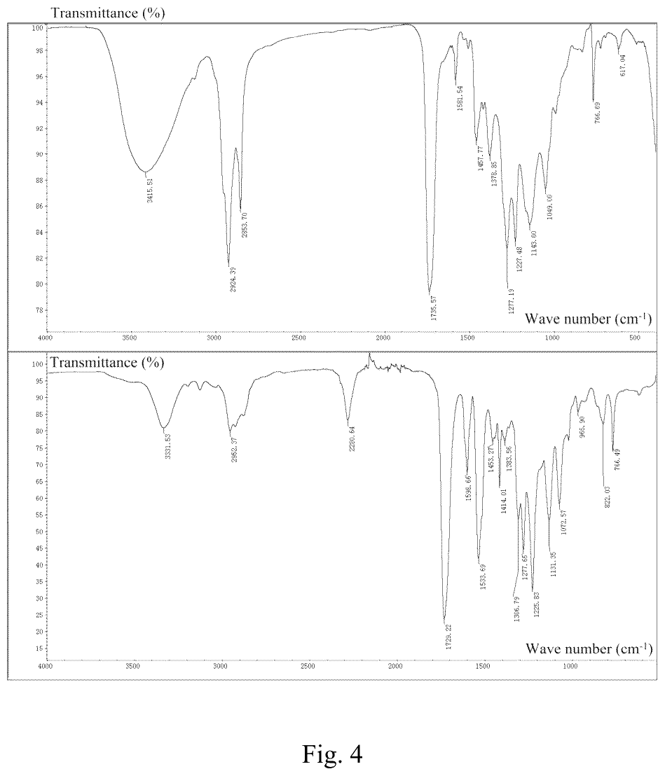

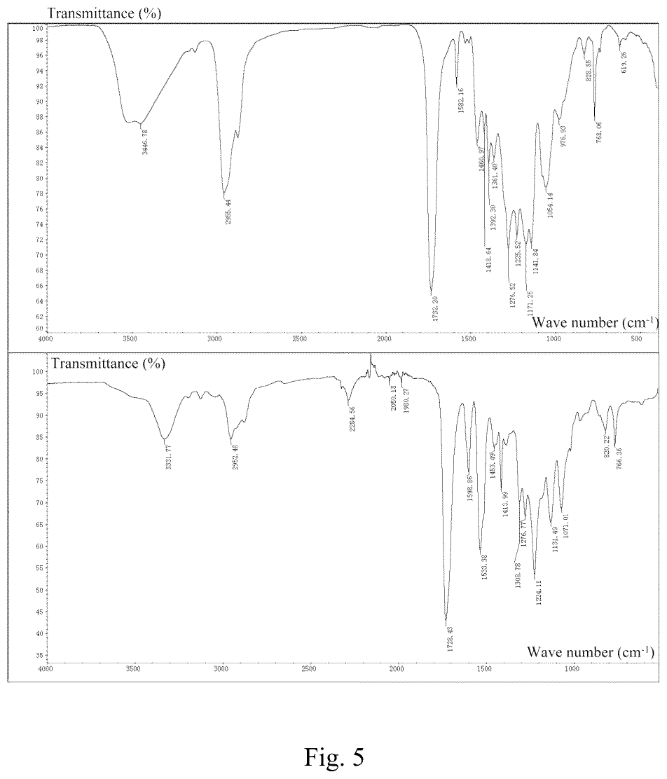

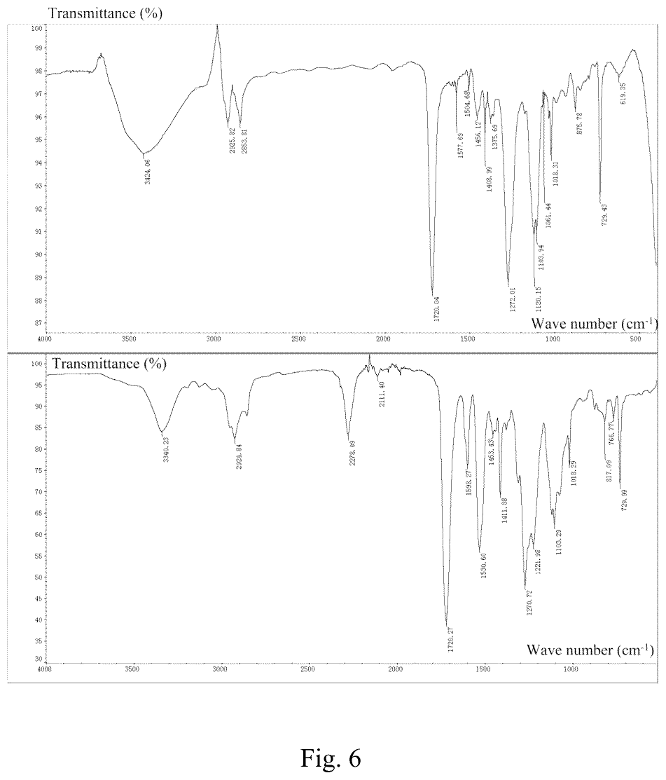

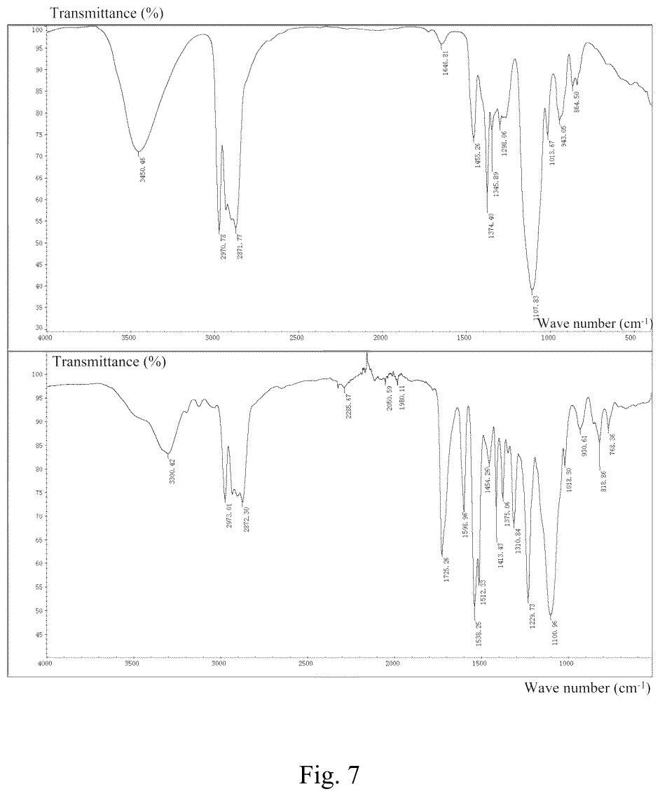

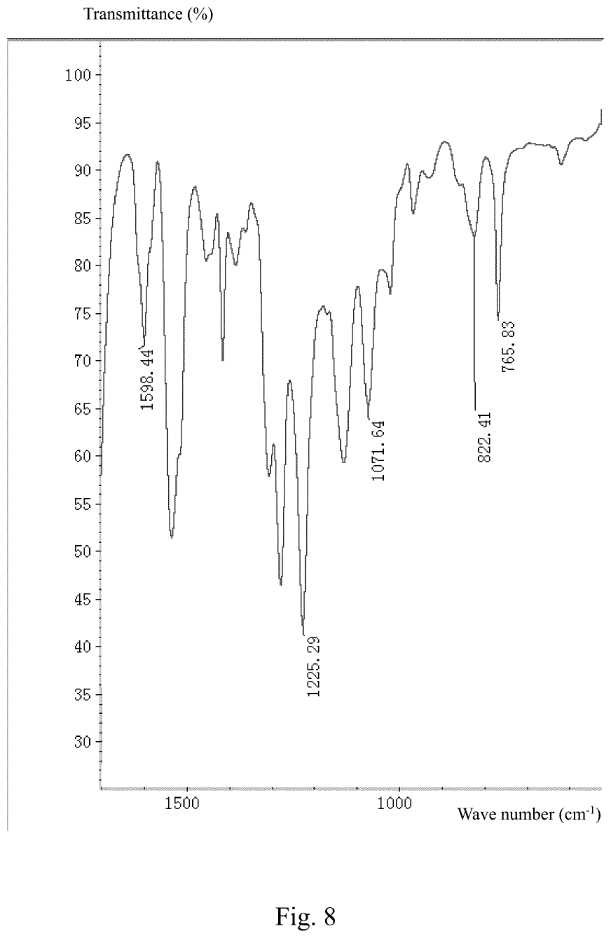

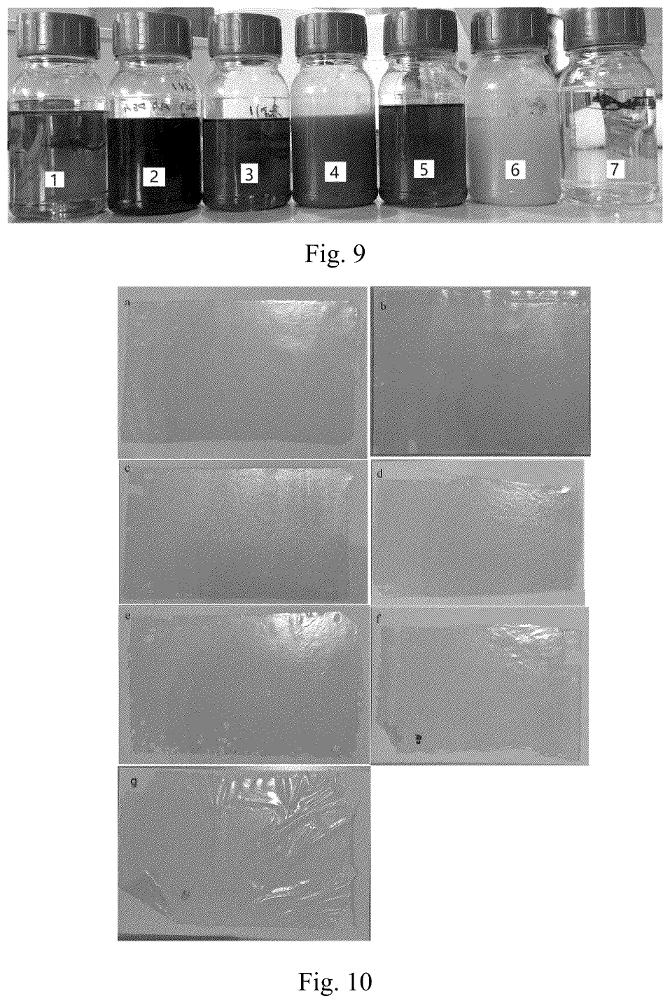

The polyester polyols of the above embodiments and comparative examples are thinly coated on quartz sheets, respectively; and then are performed infrared detection by attenuated total reflection (ATR). The polyurethane films are cut into 1 cm×1 cm slices, the infrared spectra of these slices are detected, and detection results are shown in FIGS. 1-7, respectively.

### (2) Viscosity Testing

The viscosity of the polyester polyols in the above embodiments and comparative examples is tested according to GB/T12008/7-2010 standard, and the results are included in Table 1.

### (3) Hydroxyl Value Determination

According to GB/T12008.3-2009 standard, the hydroxyl values of the polyester polyols in the above embodiments and comparative examples are tested by phthalic anhydride method, and the results are included in Table 1.

### (4) Release Period Test

At 25° C., the release period of the polyurethane controlled release fertilizer of the above embodiments and comparative examples is tested by water extraction method, the release rate at 24-hour is taken as the initial release rate, the days required for the cumulative nutrient release rate to reach 80% is taken as the release period, and the results are included in Table 1.

TABLE 1

| | PT | | | | | | | | |
|---|---|---|---|---|---|---|---|---|---|
| | E1 | E2 | E3 | E4 | E5 | E6 | E7 | C1 | C2 |
| Viscosity of | 4350 | 8630 | 6440 | 8410 | 9480 | 7750 | 4230 | / | / |
| Polyester | | | | | | | | | |
| Polyol | | | | | | | | | |
| (mPa · s) | | | | | | | | | |
| Hydroxyl | 248.1 | 339.3 | 243.6 | 157.9 | 236.6 | 366.4 | 249.3 | 266.9 | 240.4 |
| Value of | | | | | | | | | |
| Polyester | | | | | | | | | |
| Polyol | | | | | | | | | |
| (mgKOH/g) | | | | | | | | | |
| Initial | 0.92 | 0.87 | 0.58 | 1.23 | 0.15 | 0.21 | 0.77 | 0.36 | 3.6 |
| Release Rate | | | | | | | | | |
| (%) | | | | | | | | | |
| Release | 60 | 63 | 72 | 44 | 82 | 85 | 66 | 76 | 35 |
| Period | | | | | | | | | |
| (days) | | | | | | | | | |

here, E1 represents the first embodiment, E2 represents the second embodiment, E3 represents the third embodiment, E4 represents the fourth embodiment, E5 represents the fifth embodiment, E6 represents the sixth embodiment, E7 represents the seventh embodiment, C1 represent the first comparative example, and C2 represents the second comparative example.

The results show that the coating material of the polyurethane controlled release fertilizer, which is made from the Bio-FDCA, has excellent controlled release performance and high bio-based carbon content. Considering the cost, in the present invention, the release period of 60 days or even more than 80 days are able to be achieved even if the amount of Bio-FDCA is low.

The above are only preferred embodiments of the present invention and are not intended to limit the present invention. In spite that the present invention is described in detail with reference to the aforementioned embodiments, for those skilled in the art, the technical schemes and some of the technical features recorded in the aforementioned embodiments are still able to be modified and equivalently substituted respectively. Any modification, equivalent replacement, improvement, etc. made within the spirit and principles of the present invention shall be included in the protection scope of the present invention.

What is claimed is:

1. A renewable material-based furandicarboxylic acid (Bio-FDCA) coating material of a polyurethane controlled release fertilizer, wherein the coating material comprises a structural unit of 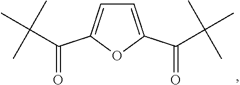
and is prepared by performing cross-linking reaction between at least one polyester polyol and at least one isocyanate, wherein the polyester polyol is made from the Bio-FDCA.

2. The coating material according to claim 1, wherein an infrared spectrum of the coating material of the polyurethane controlled release fertilizer has characteristic peaks in the range of 1598-1600 cm⁻¹, 1220-1225 cm⁻¹, 1070-1075 cm⁻¹, 818-823 cm⁻¹, and 764-768 cm⁻¹.

3. The coating material according to claim 1, wherein:
raw materials for preparing the polyester polyol comprise the Bio-FDCA, at least one organic monacid or organic binary acid, at least one polyol, and a catalyst;
the organic monacid or organic binary acid is at least one member selected from a group consisting of adipic acid, succinic acid, vegetable oleic acid and acetic acid;
the polyol is at least one member selected from a group consisting of diethylene glycol, butanediol and glycerol.

4. The coating material according to claim 1, wherein raw materials for preparing the polyester polyol, in part by weight, comprise 4-40 parts of the Bio-FDCA, 17-55 parts of the organic monacid or organic binary acid, and 30-55 parts of the polyol.

5. The coating material according to claim 1, wherein:
raw materials for preparing the polyester polyol comprise the Bio-FDCA, adipic acid, diethylene glycol, glycerol and a catalyst;
raw materials for preparing the polyester polyol comprise the Bio-FDCA, adipic acid, vegetable oleic acid, acetic acid, glycerol and a catalyst; and
raw materials for preparing the polyester polyol comprise the Bio-FDCA, adipic acid, butanediol, propylene glycol and a catalyst.

6. The coating material according to claim 5, wherein the polyester polyol is prepared by steps of:
putting the Bio-FDCA, the adipic acid, the diethylene glycol, the glycerol and the catalyst into a reaction container, performing a first refluxing for 5-10 hours after heating to 150-170° C., performing a second refluxing after heating to 200-240° C. till an acidity grade is less than 5.0 mgKOH/g, decreasing to 180-220° C., performing vacuum distillation till the acidity grade is less than 2.0 mgKOH/g and a moisture mass fraction is less than 0.1%, so as to obtain the polyester polyol with a viscosity in a range of 4000 to 10000 mPa·s, and a hydroxyl value in a range of 150 to 350 mgKOH/g.

7. The coating material according to claim 5, wherein the polyester polyol is prepared by steps of:
putting the vegetable oleic acid, the acetic acid and the glycerol into a reaction container, performing esterification reaction by heating to 160-240° C. till an acidity grade is less than 10 mgKOH/g for obtaining vegetable oleic acid glyceride, adding the Bio-FDCA, the adipic acid and the catalyst into the vegetable oleic acid glyceride, performing a first refluxing for 5-10 hours after heating to 150-170° C., performing a second refluxing after heating to 200-240° C. till the acidity grade is less than 5.0 mgKOH/g, decreasing to 180-220° C., performing vacuum distillation till the acidity grade is less than 2.0 mgKOH/g and a moisture mass fraction is less than 0.1%, so as to obtain the polyester polyol with a viscosity in a range of 7000 to 10000 mPa·s, and a hydroxyl value in a range of 200 to 400 mgKOH/g.

8. The coating material according to claim 5, wherein the polyester polyol is prepared by steps of:
putting the Bio-FDCA, the adipic acid, the butanediol, the propylene glycol and the catalyst into the reaction container, performing a first refluxing for 5-10 hours after heating to 150-170° C., performing a second refluxing after heating to 200-240° C. till an acidity grade is less than 5.0 mgKOH/g, decreasing to 180-220° C., performing vacuum distillation till the acidity grade is less than 2.0 mgKOH/g and a moisture mass fraction is less than 0.1%, so as to obtain the polyester polyol with a viscosity in a range of 4000 to 8000 mPa·s, and a hydroxyl value in a range of 200 to 400 mgKOH/g.

9. The coating material according to claim 4, wherein by mass percentage, the Bio-FDCA accounts for 4% to 40% of the polyester polyol.

10. The coating material according to claim 4, wherein the isocyanate comprises petroleum-based polymethylene polyphenyl polyisocyanate and bio-based polymethylene polyphenyl polyisocyanate; the isocyanate is at least one member selected from a group consisting of petroleum-based diphenylmethane diisocyanate (MDI), bio-based diphenylmethane diisocyanate, toluene diisocynate (TDI), p-phenylene diisocyanate (PPDI), m-xylylene Diisocyanate (XDI), cyclohexyl diisocyanate (CHDI), isophorone diisocyanate (IPDI), dicyclohexylmethane diisocyanate (HMDI), Hexamethylene diisocyanate (HDI) and Lysine diisocyanate (LDI).

11. A method for preparing a polyurethane controlled release fertilizer, comprising by spraying the coating material according to claim 1 on a surface of granular fertilizer, forming a layer of film after cross-linking in situ on the surface of the granular fertilizer, so as to obtain the polyurethane controlled release fertilizer.

12. The method according to claim 11, wherein a weight of the coating material accounts for 2-6% of that of the polyurethane controlled release fertilizer.

13. A polyurethane controlled release fertilizer, wherein the polyurethane controlled release fertilizer is prepared by a method which comprises by spraying the coating material according to claim 1 on a surface of granular fertilizer, forming a layer of film after cross-linking in situ on the surface of the granular fertilizer, so as to obtain the polyurethane controlled release fertilizer.
